(19) United States
(12) Patent Application Publication
(10) Pub. No.: US 2006/0083846 A1
(43) Pub. Date: Apr. 20, 2006

(54) Dry cherry product

(76) Inventor: Mary A. Smith, Omena, MI (US)

Correspondence Address: Bernd W. Sandt, Sandt & Associates, 900 Deerfield Court, Midland, MI, 48640, US

(21) Appl. No.: 10/655,391

(22) Filed: Sep. 4, 2003

Related U.S. Application Data
(63) Continuation-in-part of application No. 60/409,122, filed on Sep. 9, 2002.

(51) Int. Cl. A23B 7/08

(52) U.S. Cl. 426/639

(57) ABSTRACT

This invention relates to a semidry or dry cherry product that retains the flavor and nutraceutical ingredients of the original cherries and also has extended shelf life.

### FIELD OF THE INVENTION

This invention relates to dry, leathery or semi-dry, paste-like cherry products. This application is a continuation in part of my provisional application Ser. No. 60/409,122 filed Sep. 9, 2002.

### BACKGROUND OF THE INVENTION

Dried cherry products constitute a nutritious food item that combines an excellent fruit taste with low cholesterol content. This is particularly true with tart cherries, which lend themselves more readily to forming a dried product. In order to stabilize the product against becoming moldy sugar is added to the cherries. The problem with such cherry products is loss of flavor and/or firmness if sufficient sugar is added to stabilize the product for an adequate shelf life. It would therefore be desirable to have a product that provides a maximum of cherry flavor and yet is sufficiently stable so that it can be marketed. The present invention provides such a product.

### BRIEF DESCRIPTION OF THE INVENTION

The present invention is based on the discovery that a maximum of cherry flavor can be retained in a dry (leather) or semi-dry (paste) cherry product by a process comprising (a) comminuting pitted cherries at about 20 to 27° F. by cutting to a particle size of about 20-80 microns, (b) separating about 40 to 70% by weight of the juice from the comminuted cherries by centrifugation (c) adding to the resulting product concentrated cherry juice having a Brix value of at least 50, but preferably 65 or higher in sufficient quantity to reconstitute from 65 to 75% of the sugar content of the original cherries and (d) drying the resulting product at temperatures not exceeding 160° F. to a desired moisture level to form a semi-dry or dry product.

By cutting the cherries in the frozen condition rather than grinding them it is believed that more of the original cell structure can be retained which is believed in part to be the reason that the products of the present invention have a much stronger flavor than dry cherry products currently on the market. In addition to the cutting increased flavor and shelf life are obtained by using a cherry concentrate instead of regular. Also as a result of using the procedures of the present invention much if not most of the ingredients in cherries giving them their nutraceutical value are retained. The final heating step when carried out at temperatures below 160° F. apparently in addition to reducing the water content also destroys enzymes which adversely affect the taste of the product and thus allows the product to be more flavorful. The products of the present invention find utility as food products by themselves or in combination with other food products

### DETAILED DESCRIPTION OF THE INVENTION

The cherries from which the dry product (leather) or semi-dry product (paste) is made should be cleaned, ripe cherries having a Brix value of at least 12. Although only Montmorency cherries have been extensively studied from a standpoint of flavor retention and shelf stability and hence are preferably used in the present invention, the process of the present invention can be equally employed with other cherry varieties. It is important to pit the cherries in such a manner as to minimize pit breakage because crushed pits are believed to release benzaldehyde, which adds an undesirable taste to the concentrate and causes problems when using a microprocessor in the further handling of the cherries.

The pitted cherries should be frozen (without added sugar) and stored for at least 30 days but preferably for at least 60 days before the juice is separated from the solid. Storage of the frozen cherries improves the content of the flavor components in the final product. After the stored cherries have been thawed to a semi-frozen state generally in the range of 20 to 27° F., they are comminuted into particles of 20-80 microns using commercially available cutting machines such as a “Urschel Commitrol” microprocessor and the resulting juice is then separated at such temperatures from the comminuted mixture by such methods as centrifuging or gravity separation. In the alternative it is also possible to comminute the fresh, pitted cherries and then freeze such for storage before juice separation.

The separation is conducted until about 40 to 70% of juice has been removed from the thawed, cut product to form a soft moist cherry solid. This solid is then recombined with concentrated cherry juice having a Brix value of at least 50 and preferably 65 or higher. Such concentrates can be obtained by the methods described in my co-pending application Ser. No. 10/638,890 filed Aug. 18, 2003. Concentrates having the required Brix value are also commercially available. After the concentrate has been evenly distributed in the separated solid cherry particulate through mixing it is then dried to lower the moisture content by heating at temperatures not exceeding 160° F. The heating step is necessary to deactivate enzymes contain in cherries that destroy the flavor of cherries when in contact with air. In the event a paste is the desired product the moisture content is reduced until about 45% of the original weight of the extracted mixture remains. In the event a leathery product is the desired product, the moisture is even further reduced until only about 23% of the weight of the extracted mixture is retained.

Although the products of the present invention are a nutritious food product all by themselves, they find greater utility in combination with other ingredients. Thus the products can be used in cookies, in cheese, added to dry cereals and used in sauces, dressings and dips.

### EXAMPLE 1

40 pounds of depitted Montmorency cherries having a Brix value of 15 were cut in a “Urschel Commitrol” microprocessor with the head having 40 blades at a temperature of about 24° F. The resulting product was bagged, frozen and stored for 60 days at freezer temperature. The frozen product was then placed on a strainer and allowed to partially thaw at room temperature. The juice was collected until about 30% of the original frozen product was retained on the strainer. The resulting wet solid, about twelve pounds, was then mixed with 3.5 pounds of concentrated cherry juice having a Brix value of 68. After mixing, the product was placed in pans in an oven at about 260° F. although the temperature at the surface of the mixed product was maintained at temperatures below 160° F. by removing the product from the oven and stirring the product. The heating step was continued until the product weighed about 7 pounds and had the consistency of a heavy paste. The product was sweet with a strong cherry flavor.

A similar mixture of wet cherry solid mixed with cherry concentrate was placed into shallow pans to a depth about 0.75″ and dried at temperatures between about 110 and 140° F. When the surface appeared to be dry the product was removed from the pan and placed on a screen. The drying was continued until the weight of the mixture was reduced to about 23% of the original weight. The resulting product was a solid but chewable food product that had a sweet cherry flavor.

### EXAMPLE 2

200 g of frozen depitted Montmorency cherries were cut in a Urschel Commitrol microprocessor at temperatures of about 24° F. The resulting product was then placed at a temperature of about 20° F. in the basket of a small commercially available centrifuge and extracted at about 1000 rpm until about 120 g of the original weight remained in the basket. This product was mixed with 28 g of cherry juice concentrate having a Brix of 68. The mixture was then heated at 140 to 160° F. until the remaining product weighed about 40 g. A semi-solid cherry paste was obtained that had a strong cherry flavor.

1. (canceled)

2. (canceled)

3. (canceled)

4. (canceled)

5. (canceled)

6. (canceled)

7. (canceled)

8. (canceled)

9. (canceled)

10. (canceled)

11. A process for preparing a solid cherry nutraceutical product comprising (a) comminuting pitted cherries by cutting to a particle size of about 20-80 microns at temperatures of 20-27° F., (b) separating about 40 to 70 weight % of juice form the comminuted cherries by gravity or centrifugation (c) adding concentrated cherry juice having a Brix value of at least 50 to the solid product, in sufficient quantity to reconstitute from two thirds to three fourth of the sugar content of the original cherries and (d) drying the resulting product at temperatures not exceeding 160° F. to a desired moisture level to form a semi-dry or dry product.

12. The process of claim 11 wherein the separation is carried out through centrifugation.

13. The process of claim 11 wherein the cherries are Montmorency cherries having a Brix value of at least 12.

14. The process of claim 11 wherein the cherries have been maintained in a frozen state for at least sixty days before extraction.

15. The process of claim 11 wherein ⅔ of the sugar in the original cherries is added in the form of a cherry concentrate having a Brix value of 65-68.

16. The process of claim 11 wherein the drying step is conducted until a paste is formed.

17. The nutraceutical food product of claim 16.

18. The process of claim 11 wherein the drying step is continued until a leather-like product is formed.

19. The nutraceutical product of claim 18.

20. The process of claim 11 wherein the added cherry concentrate has a Brix value of 68.
